(19) United States
(12) Patent Application Publication
(10) Pub. No.: US 2013/0313759 A1
(43) Pub. Date: Nov. 28, 2013

(54) Manufacturing method of a retaining wall of an LED

(71) Applicants: ChungSeok Lee, Suwon (KR); DongMyung Kim, Suwon (KR); Gil Mo Nam, Suwon (KR); YoungKi Kim, Suwon (KR); JongSoo Ha, Suwon (KR)

(72) Inventors: ChungSeok Lee, Suwon (KR); DongMyung Kim, Suwon (KR); Gil Mo Nam, Suwon (KR); YoungKi Kim, Suwon (KR); JongSoo Ha, Suwon (KR)

(73) Assignees: AAC TECHNOLOGIES HOLDINGS INC., CAYMAN ISLANDS (GB); AAC ACOUSTIC TECHNOLOGIES (SHENZHEN) CO., LTD, Shenzhen (CN)

(21) Appl. No.: 13/902,428

(22) Filed: May 24, 2013

(30) Foreign Application Priority Data
May 25, 2012 (CN) 201210166648.7

(51) Int. Cl. B29C 35/08

(52) U.S. Cl. CPC B29C 35/0805
USPC 264/496

(57) ABSTRACT

A manufacturing method of a retaining wall of a light emitting diode includes the steps of: providing a ceramic substrate; providing a soft mold having a plurality of molding concaves; forming plurality of electrode groups on the ceramic substrate; filling the ceramic slurry into the corresponding molding concaves; pressing the soft mold on the ceramic substrate; forming a plurality of retaining walls by curing the ceramic slurry using UV curing porcess and connecting the retaining walls on the ceramic substrate by pressing the soft mold; and separating the soft mold from the ceramic substrate. Compared with the traditional technology, the manufacturing method of the present invention is quite simple and can greatly reduce the process steps of screen printing for improving the production efficiency.

### FIELD OF THE INVENTION

The present invention relates to the art of LED (Light Emitting Diode), more particularly to a manufacturing method of a retaining wall of an LED used in a portable electric product.

### BACKGROUND OF THE INVENTION

With the quick development of electric products, more especially, the portable electric products, such as cellphone, notebook etc., people have stronger requirements for the functions not only of the acoustic performance of communication, but also of the optical performance of the camera. Thereby, LED lens equipped with the portable electronic devices for providing photographic functions are more and more used.

A related LED lens generally comprises a substrate, an LED unit disposed on the substrate, and a lens unit for packaging the LED unit.

However, the cost of the lens unit is high as the Lens unit is manufactured by die casting. For solving the problem of high cost, another packaging method following the process sequence “printing-drying-printing” is used to form a retaining wall by screen printing. In this packaging method, simple drying process is used to form the retaining wall by drying the printing materials, which leads the retaining wall to deform due to the pressure from the printing screen during reduplicate printing processes. If the retaining wall needs to reach 150 um high, at least ten times of printing processes should be applied, which seriously lower the efficiency of the packaging process.

In view of above, a new manufacturing method of a retaining wall of an LED is disclosed to solve the above mentioned problems.

### BRIEF DESCRIPTION OF THE DRAWINGS

The foregoing advantages of the invention will be appreciated more fully from the following further description thereof with reference to the accompanying drawings wherein:

FIG. 1 is an illustrative scheme of the steps A and B of a manufacturing method in according with an exemplary embodiment of the present invention;

FIG. 2 is an illustrative scheme of the steps C and D of the manufacturing method;

FIG. 3 is an illustrative scheme of the step E of the manufacturing method;

FIG. 4 is an exploded view of an LED according to the exemplary embodiment of the present invention;

FIG. 5 is a partial structural isometric view of the LED according to the exemplary embodiment of the present invention.

### DESCRIPTION OF ILLUSTRATIVE EMBODIMENT

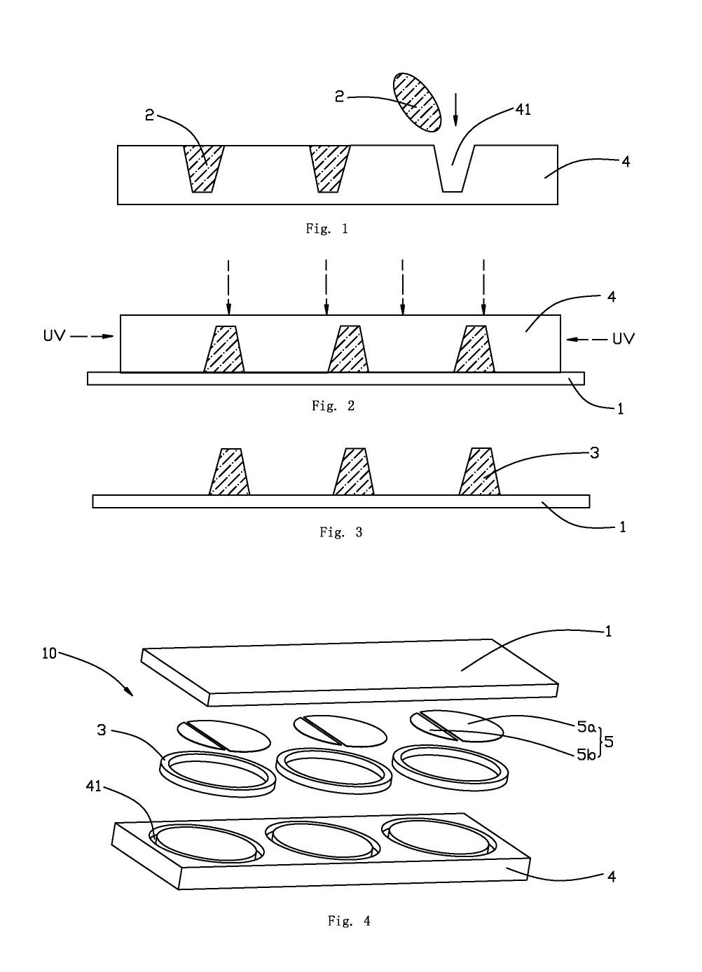

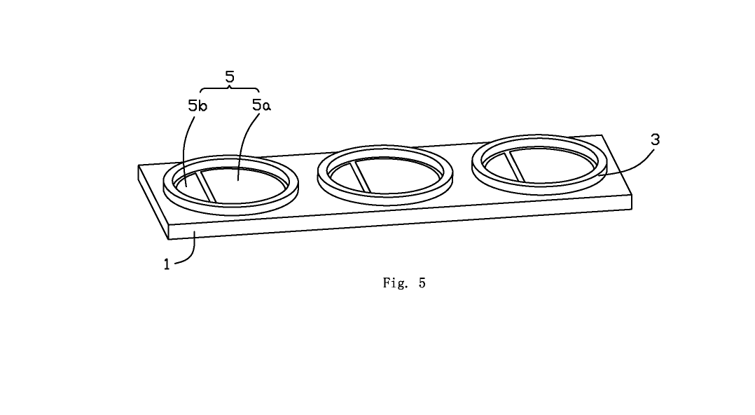

As shown in FIGS. 1-5, a manufacturing method of a retaining wall of an LED, comprises the following steps:

step A: providing a ceramic substrate 1;

providing a soft mold 4 having a plurality of molding concaves 41. The material of the soft mold is polymeric material, which may be selected from Polydimethysiloxane, Polyurethane acrylate, Epoxy and Polyethylene terephthalate, wherein the material of the soft mold is selected according to the hardness of the polymeric material, and the soft mold is formed by photolithography process;

providing ceramic slurry 2;

step B: as shown in FIG. 1, forming plurality of electrode groups 5 on the ceramic substrate 1 for electrically connecting with the LED, each electrode group comprising a positive electrode 5a and a negative electrode 5b;

filling the ceramic slurry 2 into the corresponding molding concaves 41;

step C: as shown in FIG. 2, pressing the soft mold 4 on the ceramic substrate 1 after the molding concave 41 filled with the ceramic slurry 2 and faced the corresponding electrode group 5, wherein, in this step, each molding concave 41 surrounds the corresponding electrode group 5;

step D: forming a plurality of retaining walls 3 by curing the ceramic slurry 2 using UV curing process and connecting the retaining walls 3 on the ceramic substrate 1 by pressing the soft mold 4;

step E: as shown in FIG. 3, removing the soft mold 4 from the ceramic substrate 1.

The retaining walls 3 are cured by the ceramic slurry 2 and directly shaped by the molding concave 41, thereby preventing the distortion or deformation of the retaining walls 3. A height of each retaining wall is 50 μm to 500 μm and a wide of each retaining wall is 50 μm to 200 μm.

In the embodiment of the present invention, the electrode groups 5 are formed on the ceramic substrate 1 by silver plating, and in alternative embodiments, the electrode groups 5 may be formed by other available methods, such as by printed circuit boards (PCB), flexible printed circuit broads (FPCB), plating copper lines, and so on.

Optionally, the ceramic slurry 3 comprises 60-80 percent inorganic matters and 20-40 percent organic matters. The inorganic matters comprise white glass-ceramic and the organic matters comprise dispersant agent, polymer, light initiator or solvent.

Compared with the traditional technology, the manufacturing method of the present invention is quite simple and can greatly reduce the process steps of screen printing for improving the production efficiency. The retaining wall is formed by white ceramic slurry, which can further improve reflectivity of the retaining wall for increasing heat transfer and luminous efficiency. Therefore, the reliability of the LED can be improved.

Although the above discussion discloses various exemplary embodiments of the invention, it should be apparent that those skilled in the art can make various modifications that will achieve some of the advantages of the invention without departing from the true scope of the invention.

What is claimed is:

1. A manufacturing method of a retaining wall of a light emitting diode, comprising the steps of:
step A, providing a ceramic substrate;
providing a soft mold having a plurality of molding concaves, the material of the soft mold being polymeric material;
providing ceramic slurry;
step B, forming a plurality of electrode groups on the ceramic substrate, each electrode group comprising a positive electrode and a negative electrode;
filling the ceramic slurry into the corresponding molding concaves;
step C, pressing the soft mold on the ceramic substrate after the molding concave filled with the ceramic slurry and faced the corresponding electrode group;
step D, forming a plurality of retaining walls by curing the ceramic slurry using UV curing process and connecting the retaining walls on the ceramic substrate by pressing the soft mold;
step E, removing the soft mold from the ceramic substrate.

2. The manufacturing method of claim 1, wherein the soft mold is selected from Polydimethysiloxane, Polyurethane acrylate, Epoxy and Polyethylene terephthalate.

3. The manufacturing method of claim 1, wherein the ceramic slurry comprises 60-80 percent inorganic matters and 20-40 percent organic matters.

4. The manufacturing method of claim 1, wherein a height of each retaining wall is 50 to 500 um and a wide of the retaining wall is 50 to 200 um.

5. The manufacturing method of claim 1, wherein the soft mold is formed by photolithography process.
